(19) United States
(12) Patent Application Publication
(10) Pub. No.: US 2010/0049496 A1
(43) Pub. Date: Feb. 25, 2010

(54) Word translation enquiry system across multiple thesauri and the method thereof

(75) Inventors: Chaucer Chiu, Taipei (TW); Xinjun Cheng, Shanghai (CN)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 12/230,051

(22) Filed: Aug. 22, 2008

(51) Int. Cl. G06F 17/28

(52) U.S. Cl. 704/2

(57) ABSTRACT

A word translation enquiry system across multiple thesauri and the method thereof are provided. After finding the correlation value of a word in one database is found, it is checked in a word correlation table to find multiple identification codes and index values. According to the identification code and index value, the translation of the word in different databases can be obtained following the index value. This solves the problem of being unable to search translations of a term in multiple databases.

### BACKGROUND OF THE INVENTION

1. Field of Invention

The invention relates to a translation enquiry system and the method thereof and, in particular, to a cross-database translation system that search a word across several databases.

2. Related Art

Current translation systems have the goal of establishing correspondence relations between an original language and a target language and then converting the original language to the target language. The database in a translation system is generally called a thesaurus. During the establishment of thesauri, each one is independent of one another. Therefore, the user has to explicitly specify which one to use. For example, if the user uses an English-Chinese dictionary, the corresponding database is the English-Chinese thesaurus.

Since the thesauri in a translation system are independent of one another, there comes the function of looking up words in multiple thesauri. That is, the word is looked up among the thesauri in the order defined by the system. After the user enters a word to search, it is looked up in the thesauri according to the order specified by the system. The translation and explanation of the word are always looked up in the first thesaurus. If the word is found, the system shows the translation and explanation thereof. If it is not found in the first thesaurus, it is looked up in the second thesaurus. When it is found, the system shows the translation and explanation thereof. If the word is not found again, it is further searched in the next thesaurus, until the word is found or all the thesauri have been searched.

Following the above-mentioned method, the user cannot adjust the thesaurus searching order at his will. Each search follows a fixed order. Not only are such searches slow, this method cannot meet different needs of the user.

Therefore, a smart cross thesaurus searching method is proposed. In this method, the number of times each thesaurus is selected is used to rearrange the search order of the databases. It is thus hoped that the user can quickly perform searches in desired thesauri.

The above-mentioned two methods can only search for translations in a single thesaurus. They cannot find all the explanations in different thesauri. Therefore, strictly speaking, the prior art cannot achieve the goal of searching words in multiple thesauri.

To summary, the prior art always has the inadequacy in searching translations of words in multiple databases. It is therefore imperative to provide an improve technique to solve the problem.

### SUMMARY OF THE INVENTION

In view of the foregoing, the invention discloses a word translation enquiry system across multiple thesauri and the method thereof.

The disclosed word translation enquiry system across multiple thesauri includes a thesaurus identification module, a thesaurus language module, a word correlation module, a generating module, an input module, a searching module, a correlation searching module, and a display module.

The thesaurus identification module associates an identification (ID) code to each digital thesaurus. The thesaurus language module associates a language code to the original language of each digital thesaurus. The word correlation module establishes index values and correlation values for all the words in the digital thesaurus. The generating module generates a thesaurus correlation table using the language code as the correlation table name, the correlation value as the correlation index, and the ID codes along with the index values as the table contents. The input module receives a word to be searched. The searching module searches for the explanation and correlation value of the word in the digital thesaurus corresponding to the original language of the word. The correlation searching module finds the ID code and index value in the thesaurus correlation table according to the correlation value, and searches for the explanation associated with the index value corresponding to the ID code in the digital thesaurus. The display module displays the word and all its translated explanations.

The disclosed method of searching for translation among multiple thesauri includes the following steps.

First, associate each digital thesaurus with an ID code. Afterwards, associate a language code to the original language of each digital thesaurus. Afterwards, establish index values and correlation values for all the words in the digital thesaurus. Afterwards, generate a thesaurus correlation table using the language code as the correlation table name, the correlation value as the correlation index, and the ID codes along with the index values as the table contents. Afterwards, receive a word to be searched. Afterwards, search for the explanation and correlation value from the digital thesaurus corresponding to the original language of the word. Afterwards, find the corresponding ID code and index value in the thesaurus correlation table according to the correlation value, and search for the translated explanation associated with the index value corresponding to the ID code in the digital thesaurus. Finally, display the word and all its translated explanations.

The disclosed system and method are described above. The difference between the invention and the prior art is in that the thesaurus correlation table generated by the invention can truly realize the function of cross thesaurus searching. After obtaining the correlation value of a word in one of the thesauri, the invention can find many ID codes and index values from the thesaurus correlation table according to the correlation value. According to the ID code and index value, the invention can obtain the translated explanation associated with the index value in the thesaurus corresponding to the ID code.

Using the above-mentioned technique, the invention can simultaneously search for the translated explanations in different thesauri.

### BRIEF DESCRIPTION OF THE DRAWINGS

The invention will become more fully understood from the detailed description given herein below illustration only, and thus is not limitative of the present invention, and wherein:

FIG. 1 is the block diagram of the disclosed word translation enquiry system across multiple thesauri;

FIG. 2 is the flowchart of the disclosed word translation enquiry method across multiple thesauri;

FIGS. 3A to 3C are schematic views showing the construction of index values and correlation values for the thesauri;

FIGS. 4A and 4B are schematic views generating the disclosed thesaurus correlation table; and

FIG. 5 is a schematic view of the disclosed translation enquiry interface.

### DETAILED DESCRIPTION OF THE INVENTION

The present invention will be apparent from the following detailed description, which proceeds with reference to the accompanying drawings, wherein the same references relate to the same elements.

Those Chinese characters shown in the following descriptions or in the drawings are just mentioned for describing the embodiments and are substantially irrelevant to any technical matters.

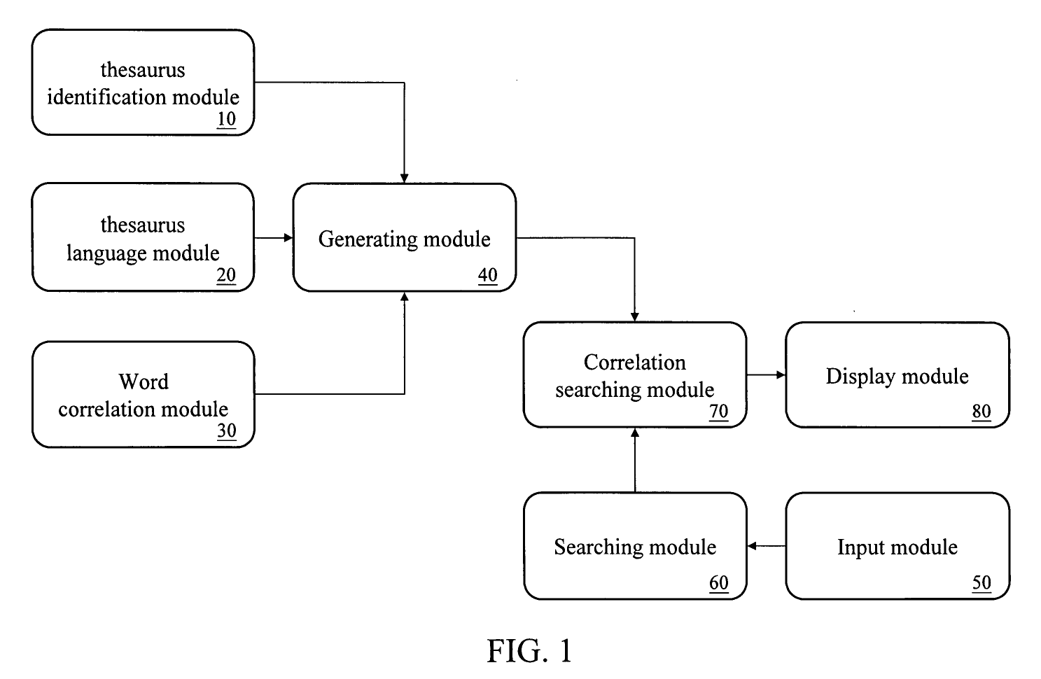

The following paragraphs explain the disclosed word translation enquiry system across multiple thesauri. Please refer to FIG. 1, the system block diagram of the invention. The disclosed word translation enquiry system across multiple thesauri includes: a word identification module 10, a thesaurus language module 20, a word correlation module 30, a generating module 40, an input module 50, a searching module 60, a correlation searching module 70, and a display module 80.

The thesaurus identification module 10 associates each digital thesaurus with a unique ID code for clearly identifying the digital thesaurus. For example, suppose there are English-Chinese thesaurus, Chinese-English thesaurus, and English-Picture thesaurus. The thesaurus identification module 10 associates each of them a unique ID code: the English-Chinese thesaurus has ID code 1, the Chinese-English thesaurus has ID code 2, and the English-Picture thesaurus has ID code 3. If there are more thesauri, the thesaurus identification module 10 associates a unique ID code to each of them.

The thesaurus language module 20 associates a language code according to the original language of each digital thesaurus for clearly identifying the original language thereof. The original language referred herein is the language of the input word to be searched.

For example, suppose there are English-Chinese thesaurus, Chinese-English thesaurus, and English-Picture thesaurus. The thesaurus language module 20 associates a language code to each of them: the English-Chinese thesaurus has language code 1, the Chinese-English thesaurus has language code 2, and the English-Picture thesaurus has language code 1. If there are more thesauri, the thesaurus language module 20 associates a language code to each of them according to its original language.

The above-mentioned English-Chinese thesaurus has English as its original language and Chinese as its target language. A word in the original language is translated into the target language according to the correspondence relation between the two languages. The English-Picture thesaurus uses English as its original language and pictures as its target pictures. A word in the original language is converted into a picture in the target pictures according to the correspondence relation between the language and the pictures.

The word correlation module 30 establishes index values and correlation values of all the words in a digital thesaurus. The index value is used to quickly find the corresponding word in the digital thesaurus. The correlation value is used to indicate its correlation with corresponding words in the other thesauri.

Take the English-Chinese thesaurus as an example. The word correlation module 30 establishes in sequence the index values and correlation values for all the words in the English-Chinese thesaurus. The first word in the English-Chinese thesaurus is ‘a’. Therefore, the correlation module 30 assigns the index value 1 and correlation value 1 for the word ‘a’, and so on, until all the words in the English-Chinese thesaurus are associated with index values and correlations values.

The generating module 40 generates a thesaurus correlation table. It uses the language code of each thesaurus as the name of a correlation table. The correlation values are the indices of the correlation table. The ID codes along with index values form the contents of the correlation table.

First, the generating module 40 extracts all the digital thesauri with the same language code and names the correlation table using it. The correlation values in the extracted digital thesauri and the ID codes and index values in the digital thesauri corresponding to the correlation values are stored in the thesaurus correlation table in a corresponding way.

Afterwards, the generating module 40 then extracts digital thesauri with different language codes. It finds according to the thesaurus correlation table the same correlation value for digital thesauri of different language codes. It also finds the ID codes and index values from the digital thesauri according to the correlation value. The correlation values, the ID codes, and the index values are stored in the thesaurus correlation table in a corresponding way. Through such a process, the generating module 40 generates the thesaurus correlation table.

After the generating module 40 generates the thesaurus correlation table, the input module 50 receives a word entered by the user for searching. The received word is sent to the searching module 60.

After the searching module 60 receives the word transmitted from the input module 50, the word is used as an original language to search for its translated explanation and correlation value in the corresponding digital thesaurus. For example, if the user enters a Chinese word, the system searches the Chinese-English thesaurus and obtains its translated explanation and correlation value.

After the searching module 60 finds the correlation value corresponding to the word, the correlation value is sent to the correlation searching module 70. After receiving the correlation value, the correlation searching module 70 uses it to find the corresponding ID code and index value in the thesaurus correlation table. At least one set of ID code and index value is found. The translated explanation corresponding to the index value is then obtained from the digital thesaurus with the corresponding ID code.

For example, suppose the ID codes found by the correlation searching module for the correlation value is ‘1’ and ‘2’, and the index values are ‘93’ and ‘83’. Then the system finds the translated explanation with the index value ‘93’ from the English-Chinese thesaurus with the ID code ‘1’, and find the translated explanation with the index value ‘83’ from the English-Chinese thesaurus with the ID code ‘2’.

Finally, the correlation searching module 70 sends all the translated explanations to the display module 80. The display module 80 then displays the word and all of its translated explanations.

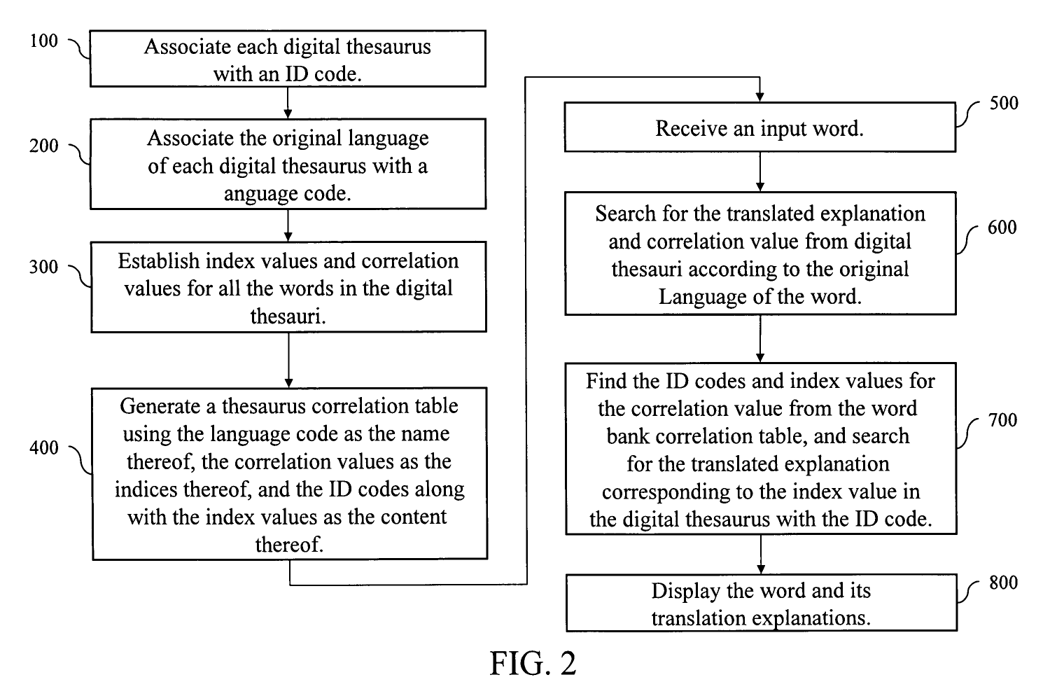

In the following, an embodiment is used to explain the operating detail and procedure of the invention. Please refer simultaneously to FIGS. 2, 3A to 3C, 4A to 4B, and 5.

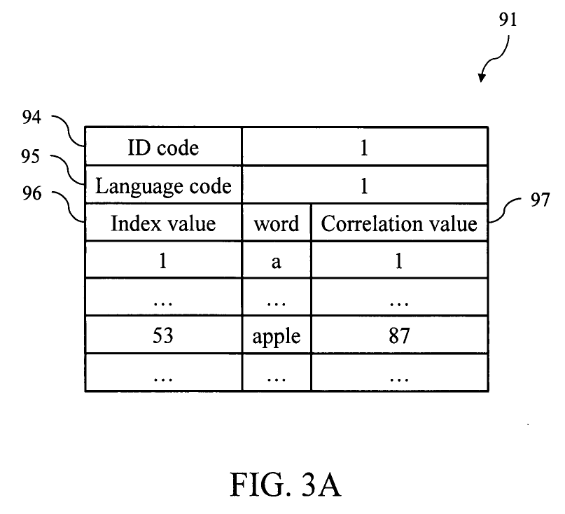

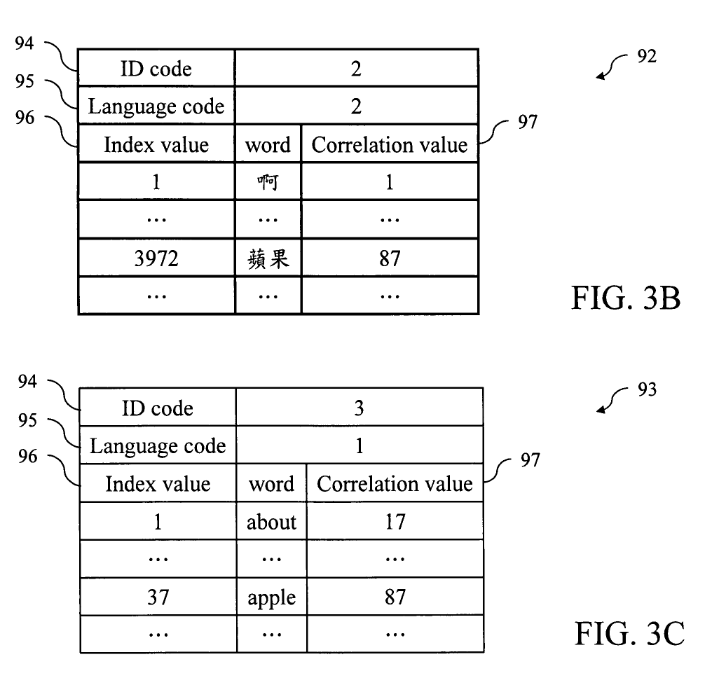

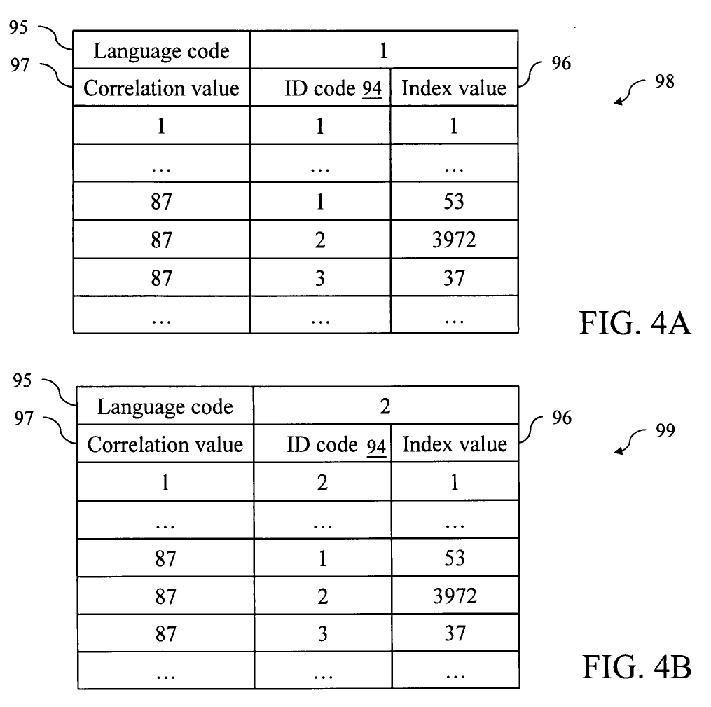

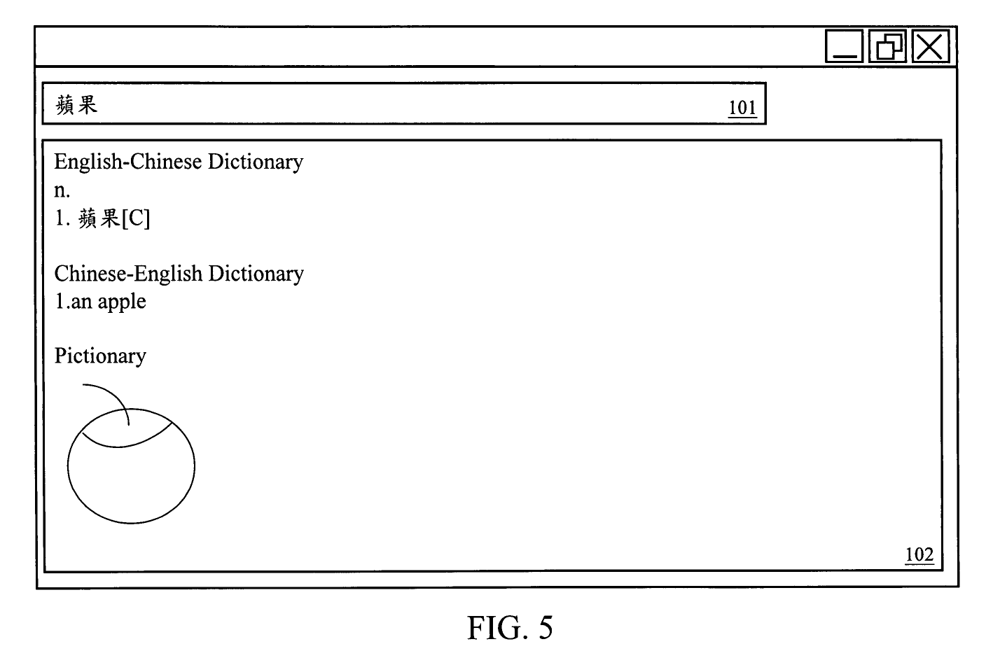

FIG. 2 is a flowchart of the disclosed word translation enquiry method across multiple thesauri. FIGS. 3A to 3C are schematic views showing the construction of thesaurus index values and correlation values according to the invention. FIGS. 4A and 4B are schematic view of generating the thesaurus correlation table according to the invention. FIG. 5 shows the translation enquiry interface of the invention.

This embodiment involves English-Chinese thesaurus 91, Chinese-English thesaurus 92, and English-Picture thesaurus 93. Here FIG. 3A represents the English-Chinese thesaurus 91, FIG. 3B the Chinese-English thesaurus 92, and FIG. 3C the English-Picture thesaurus 93. However, the invention is not restricted to this example.

As shown in FIGS. 3A to 3C, the thesaurus identification module 10 associates a unique ID code 94 to each of the digital thesauri (step 100) for clearly identifying the digital thesauri.

In this embodiment, the thesaurus identification module 10 associates the English-Chinese thesaurus 91 with the ID code 94 ‘1’, the Chinese-English thesaurus 92 with ‘2’, and the English-Picture thesaurus 93 with ‘3’. The ID codes 94 of the three thesauri are unique.

Afterwards, the thesaurus language module 20 associates a language code 95 to each digital thesaurus according to its original language (step 200) for clearly indicating the original language used in the digital thesaurus.

In this embodiment, the English-Chinese thesaurus 91 has English as its original language. Therefore, the thesaurus language module 20 sets the language code 95 of the Chinese-Chinese thesaurus 91 as ‘1’. The Chinese-English thesaurus 92 uses Chinese as its original language. Therefore, the thesaurus language module 20 sets the language code 95 of the Chinese-English thesaurus 92 as ‘2’. The English-Picture thesaurus 93 also has English as its original language. Therefore, the thesaurus language module 20 sets the language code 95 of the English-Picture thesaurus 93 as ‘1’.

Afterwards, the word correlation module 30 establishes the index values 96 and correlation values 97 of all the words in the digital thesauri (step 300). The index value 96 is used to quickly search for and locate words in the digital thesaurus. The correlation value 97 is used to correlate the corresponding words in all the thesauri.

In this embodiment, the first word in the English-Chinese thesaurus 91 is ‘a’. Therefore, the word correlation module 30 sets the index value 96 of ‘a’ as ‘1’ and the correlation value 97 thereof as ‘1’ too. Take another word ‘apple’ in the English-Chinese thesaurus 91 as an example. The word correlation module 30 sets its index value 96 as ‘53’ and its correlation value 97 as ‘87’.

The first word in the Chinese-English thesaurus 92 is [symbol] . Therefore, the word correlation module 30 sets its index value as ‘1’ and its correlation value 97 as ‘1’ too. Take another phrase [symbol] in the Chinese-English thesaurus 92 as an example. The word correlation module 30 sets its index value 96 as ‘3972’ and its correlation value 97 as ‘87’.

The first word in the English-Picture thesaurus 93 is ‘about’. Therefore, the word correlation module 30 sets its index value 96 as ‘1’ and its correlation value 97 as ‘17’. Take another word ‘apple’ in the English-Picture thesaurus 93 as an example. The word correlation module 30 sets its index value 96 as ‘37’ and its correlation value 97 as ‘87’.

Afterwards, please refer to FIGS. 3A to 3C and FIGS. 4A to 4B. After the English-Chinese thesaurus 91, the Chinese-English thesaurus 92, and the English-Picture thesaurus 93 have established all the required ID codes 94, language codes 95, index values 96, and correlation values 97, the generating module 40 generates thesaurus correlation tables, using the language codes as their names, the correlation values as their indices, and the ID codes along with index values as their contents (step 400).

In this embodiment, the generating module 40 first extracts the digital thesaurus with the language code 95 ‘1’, i.e., the English-Chinese thesaurus 91 and the English-Picture thesaurus 93, and finds the same correlation value 97 therein. The correlation value 97 thus found is ‘87’. The correlation value 97 of ‘87’ in the English-Chinese thesaurus 91 has the ID code 94 ‘1’ and index value 96 ‘93’. In the English-Picture thesaurus 93, the corresponding ID code 94 and correlation value 96 are ‘3’ and ‘37’, respectively. Afterwards, the generating module 40 stores the correlation value 97 of ‘87’, the ID code 94 of ‘1’, and the index value 96 of ‘53’ into the content of the English thesaurus correlation table 98. It also stores the correlation value 97 of ‘87’, the ID code 94 of ‘3’, and the index value 96 of ‘37’ into the content of the English thesaurus correlation table 98. Subsequently, the generating module 40 follows the correlation value 97 of ‘87’ to search the digital thesaurus with the language code 95 of ‘2’, i.e., the Chinese-English thesaurus 92, for the ID code and index value associated with the same correlation value 97 of ‘87’, i.e., the ID code 94 of ‘2’ and the index value 96 of ‘3972’. They are stored in the English thesaurus correlation table 98 correspondingly. The generating module 40 generates the English thesaurus correlation table 98 following the above procedure. The result is shown in FIG. 4A.

For the digital thesaurus with the language code 95 of ‘2’, the generating module 40 first finds that the ID code 94 and the index value 96 corresponding to the same correlation value of ‘87’ in the Chinese-English thesaurus 92 are ‘2’ and ‘3972’, respectively. Afterwards, the generating module 40 stores the correlation value 97 of ‘87’, the ID code 94 of ‘2’, and the index value 96 of ‘3972’ correspondingly in the content of the Chinese thesaurus correlation table 99. The generating module 40 follows the correlation value 97 of ‘87’ to find the ID code and index value corresponding to the same correlation value in the digital thesauri that have the language code 95 of ‘1’, i.e. the English-Chinese work bank 91 and the English-Picture thesaurus 93. In the English-Chinese thesaurus 91, the ID code 94 and the index value 96 corresponding to the correlation value 97 of ‘87’ are ‘1’ and ‘93’, respectively. In the English-Picture thesaurus 93, the ID code 94 and the index value 96 corresponding to the correlation value 97 of ‘87’ are ‘3’ and ‘37’, respectively. They are stored correspondingly in the Chinese thesaurus correlation table 99. Following the above-mentioned procedure, the generating module 40 generates the Chinese thesaurus correlation table 99. The result is shown in FIG. 4B.

Please refer to FIG. 5. When the user enters the phrase [symbol] in the input area 101, the input module 50 receives it (step 500). Since the original language entered by the user is Chinese, the method first searches the Chinese-English thesaurus 92, finds the translated explanation of [symbol] as ‘1.an apple’, and obtains the language code 95 of ‘2’ and the correlation value 97 of ‘87’ (step 600). By obtaining the language code 95 of ‘2’ and the correlation value 97 of ‘87’, the method further searches the Chinese thesaurus correlation table 99. In this case, three sets of ID codes 94 and index values 96 corresponding to the correlation value 97 of ‘87’ are obtained: ID code 94 of ‘1’ and index value 96 of ‘53’, ID code 94 of ‘2’ and index value 96 of ‘3972’, and ID code 94 of ‘3’ and index value 96 of ‘37’ (step 700).

Following the ID code 94 and index value 96 are then used to, the method searches for translated explanations with the index values 96 of ‘53’, ‘3972’, and ‘37’ in the English-Chinese thesaurus 91 with the ID code 94 of ‘1’, the Chinese-English thesaurus 92 with the ID code 94 of ‘2’, and the English-Picture thesaurus 93 with the ID code 94 of ‘3’, respectively. The translated explanation obtained from the English-Chinese thesaurus 91 with the ID code 94 of ‘1’ is ‘n. 1. [symbol] [C]’. The search in the Chinese-English thesaurus 92 is omitted. The translated explanation obtained from the English-Picture thesaurus 92 with the ID code 94 of ‘3’ is shown in FIG. 5.

Finally, the display area 102 shows the translated explanation given by the English-Chinese thesaurus 91 as ‘n. 1. [symbol] [C]’, that given by the Chinese-English thesaurus 92 as ‘1.an apple’, and the picture given by the English-Picture thesaurus 93 (step 800). This implements word searching across multiple thesauri.

In summary, it is clear that the invention differs from the prior art in that once the correlation value of a word is found the disclosed word correlation table, it can find multiple sets of ID codes and index values. Following the ID codes and index values, the invention can obtain translated explanations associated with the index values and the corresponding thesauri. This technique solves the problem in the prior art that cannot search for words in different thesauri. The invention thus achieves the objective of searching words across multiple thesauri.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A word translation enquiry system across multiple thesauri, comprising:
a thesaurus identification module, which associates each digital thesaurus with an identification (ID) code;
a thesaurus language module, which associates each original language in the thesauri a language code;
a word correlation module, which establishes an index value and a correlation value for each word in the digital thesauri;
a generating module, which uses each language code as the name of a thesaurus correlation table, the correlation values as the indices of the thesaurus correlation table, and the ID code along with the index values as the content of the thesaurus correlation table, thereby generating the thesaurus correlation table;
an input module, which receives an input word;
a searching module, which searches for a translated explanation and its correlation value from a digital thesaurus corresponding to the original language of the word;
a correlation searching module, which uses the correlation value found by the searching module to find corresponding ID codes and index values in the thesaurus correlation table and searches for the translated explanations corresponding to the index values in the digital thesaurus with the ID codes; and
a display module, which displays the word and the translated explanations.

2. The word translation enquiry system across multiple thesauri of claim 1, wherein the ID code is unique.

3. The word translation enquiry system across multiple thesauri of claim 1, wherein the original language is the language of the input word for each of the digital thesauri.

4. The word translation enquiry system across multiple thesauri of claim 1, wherein the index values are used for searching words in the digital thesauri.

5. The word translation enquiry system across multiple thesauri of claim 1, wherein the correlation values are used to correlate words in the digital thesauri.

6. A word translation enquiry method across multiple thesauri, comprising the steps of:
associating each of the thesauri with an ID code;
associating the original language of each of the thesauri with a language code;
establishing an index value and a correlation value for each of the words in the digital thesauri;
generating a thesaurus correlation table using the language code as the name thereof, using the correlation values as the indices thereof, and using the ID codes along with the index values as the content thereof;
receiving an input word;
searching for a translated explanation and its correlation value from the digital thesaurus corresponding to the original language of the word;
finding the ID code and the index value from the thesaurus correlation table using the correlation value, and searching for the translated explanations corresponding to the index values in the digital thesaurus with the ID codes; and
displaying the word and the translated explanations.

7. The word translation enquiry method across multiple thesauri of claim 6, wherein the ID code is unique.

8. The word translation enquiry method across multiple thesauri of claim 6, wherein the original language is the language of the input word for each of the digital thesauri.

9. The word translation enquiry method across multiple thesauri of claim 6, wherein the index values are used for searching words in the digital thesauri.

10. The word translation enquiry method across multiple thesauri of claim 6, wherein the correlation values are used to correlate words in the digital thesauri.
